(19) United States
(12) Patent Application Publication
(10) Pub. No.: US 2026/0287007 A1
(43) Pub. Date: Sep. 24, 2026

(54) Deployment Devices and Methods of Use

(71) Applicant: Joshuah R. Kolasinski, Lyons, OH (US)

(72) Inventor: Joshuah R. Kolasinski, Lyons, OH (US)

(21) Appl. No.: 19/082,950

(22) Filed: Mar. 18, 2025

(51) Int. Cl. F16B 45/02; A45F 5/00; A45F 5/02

(52) U.S. Cl. CPC F16B 45/023; A45F 5/022; A45F 5/1558; F16B 45/027; F16B 2200/83

(57) ABSTRACT

A deployment device that has a carabiner, an elongate member, a first attachment member, a second attachment member, and a handle. The carabiner has a main body, a catch, and a support member. The main body has a main body first end, a main body second end, a main body lengthwise axis, and defines a void. The elongate member is attached to the support member and has an elongate member first end and an elongate member second end. The first attachment member is attached to the elongate member and comprises a first magnetic element. The second attachment member is attached to the elongate member and comprises a second magnetic element adapted to interact with the first magnetic element such that the first magnetic element and the second attachment element are magnetically attracted to one another. The handle is attached to the elongate member.

### FIELD

The disclosure relates to the field of deployment devices. More particularly, the disclosure relates to deployment devices used for quick access to an article and related methods.

### BACKGROUND

Accessing essential equipment during emergency situations can be challenging. For example, firefighters may struggle to retrieve webbing straps from pockets during a fire rescue. The chaotic environment, filled with smoke, heat, and danger, obscures visibility and makes locating specific items difficult. Furthermore, bulky protective gear restricts mobility and dexterity, further hindering the retrieval process.

A need exists, therefore, for improved deployment devices and methods of using a deployment device.

### BRIEF SUMMARY OF SELECTED EXAMPLES

Various example deployment devices and methods of using a deployment device are described.

An example deployment device comprises a carabiner, an elongate member, a first attachment member, a second attachment member, and a handle. The carabiner has a main body, a catch, and a support member. The main body has a main body first end, a main body second end, a main body lengthwise axis, and defines a void. The catch is pivotably attached to the main body and is moveable between a first position and a second position. The catch is free of the main body second end in the first position. The catch contacts the main body second end in the second position. The support member is disposed between the main body first end and the main body second end and on the lengthwise axis. The support member extends away from the void. The elongate member is attached to the support member and has an elongate member first end and an elongate member second end. The first attachment member is attached to the elongate member between the elongate member first end and the elongate member second end. The first attachment member comprises a first magnetic element. The second attachment member is attached to the elongate member between the first attachment member and the elongate member second end. The second attachment member comprises a second magnetic element adapted to interact with the first magnetic element such that the first magnetic element and the second attachment element are magnetically attracted to one another. The handle is attached to the elongate member between the second attachment member and the elongate member second end.

Additional understanding of the deployment devices and associated methods can be obtained by reviewing the detailed description of selected examples, below, and the referenced drawings.

### DESCRIPTION OF FIGURES

FIG. 1 is a front view of an example deployment device. The elongate member is shown in a first configuration.

FIG. 2 is a rear view of the example deployment device illustrated in FIG. 1.

FIG. 3 is a side view the example deployment device illustrated in FIG. 1. The elongate member is shown in a second configuration.

FIG. 4 is an isometric view of the carabiner of the deployment device illustrated in FIG. 1.

FIG. 5 is a rear view of the carabiner illustrated in FIG. 4.

FIG. 6 is a front view of the carabiner illustrated in FIG. 4.

FIG. 7 is a right side view of the carabiner illustrated in FIG. 4.

FIG. 8 is a left side view of the carabiner illustrated in FIG. 4.

FIG. 9 is a bottom view of the carabiner illustrated in FIG. 4.

FIG. 10 is a top view of the carabiner illustrated in FIG. 4.

### DETAILED DESCRIPTION OF SELECTED EXAMPLES

The following detailed description and the appended drawings describe and illustrate various example deployment devices and methods of using a deployment device. The description and illustration of these examples enable one skilled in the art to make and use an example deployment device and practice a method of using a deployment device. They do not limit the scope of the claims in any manner.

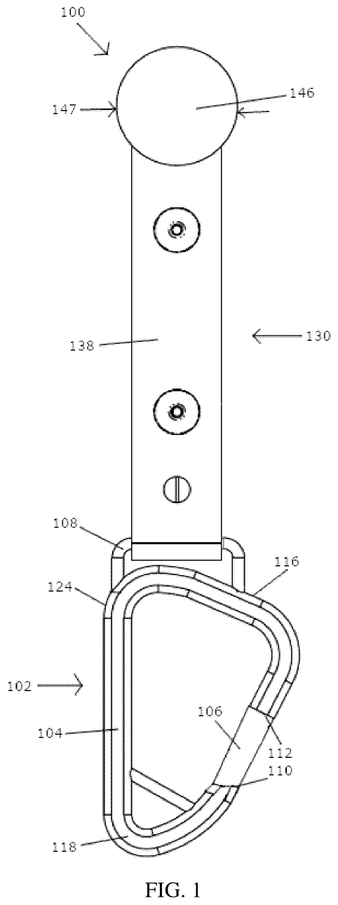

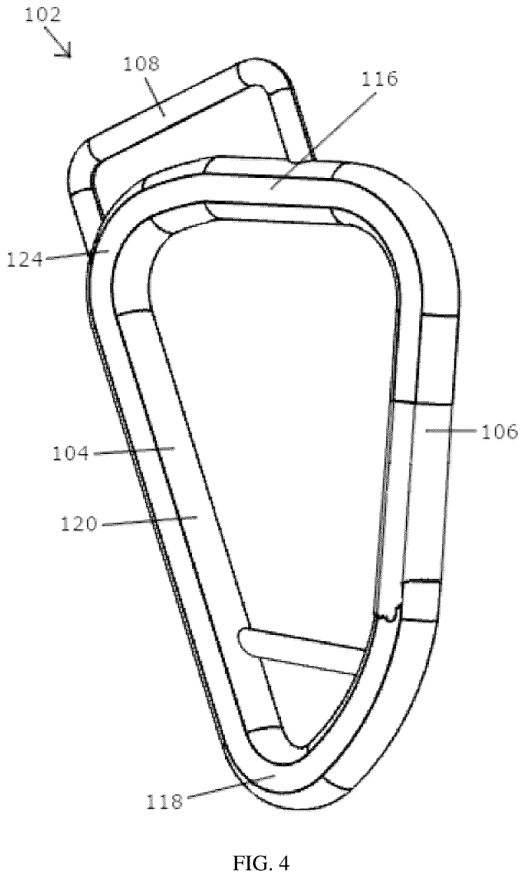

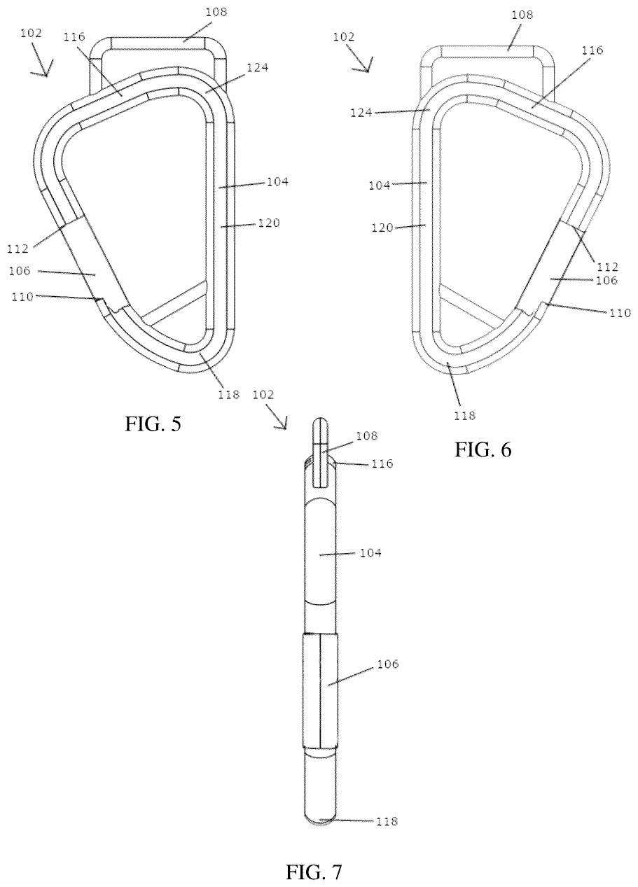

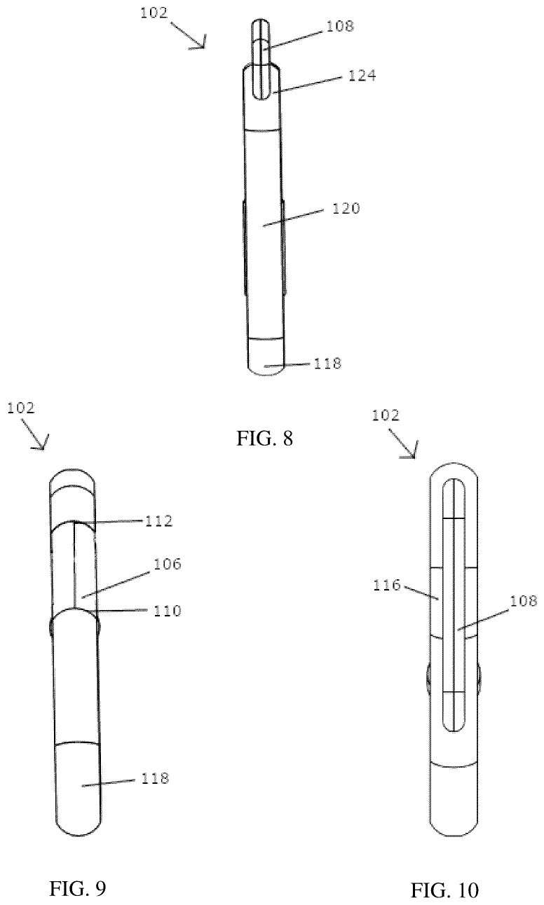

FIGS. 1 through 10 illustrate an example deployment device 100. The deployment device 100 includes a carabiner 102, an elongate member 130, a first attachment member 140, a second attachment member 142, and a handle 146.

In the illustrated embodiment, the carabiner 102, illustrated in FIGS. 1 through 10, has a main body 104, a catch 106, a support member 108, and a bridge 150. The main body 104 has a main body first end 110, a main body second end 112, a main body lengthwise axis 114, a main body top 116, a main body bottom 118, a main body first side 120, a main body second side 122, a main body first bend 124, and defines a void 126. The main body 104 extends from the main body first end 110 to the main body second end 112. The main body lengthwise axis 114 extends through the main body top 116 and the main body bottom 118. The main body top 116 extends between the main body first side 120 and the main body second side 122. The carabiner first side 120 opposably faces the carabiner second side 122 relative to the main body lengthwise axis 114. The main body first bend 124 extends from the main body top 116 and the main body first side 120. The void 126 is configured to receive an object such as, but not limited to, a strap. The carabiner 102 includes a protrusion 128 that extends the main body second end 122 and is prevents the catch 106 from extending beyond the main body second end 122.

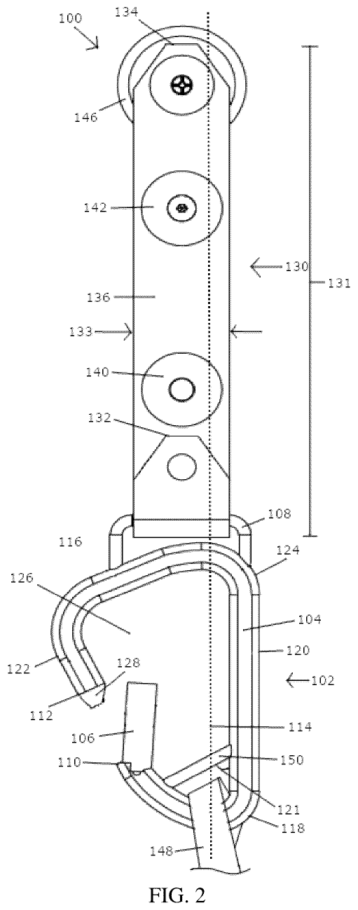

The catch 106 is pivotably attached to the main body 104 and is moveable between a first position and a second position. In the embodiment shown, the catch 106 is pivotably attached to the main body first end 110. The catch 106 is free of the main body second end 112 in the first position, as shown in FIG. 2, and the catch 106 contacts the main body second end 112 in the second position, as shown in FIG. 1. The catch can further include a locking mechanism, not illustrated, that is moveable between a locked and unlocked configuration. In the locked configuration, and when the catch 106 is in the second position, the locking mechanism maintains the position of the catch 106 and prevents the catch 106 from entering the first position such that any object within the void 126 defined by the main body 104 can be stored.

The support member 108 is disposed between the main body first end 110 and the main body second end 112 and on the lengthwise axis 114. The support member 108 extends away from the void 126. In the illustrated embodiment, the support member 108 extends from the main body 104 relatively parallel to the lengthwise axis 114. A portion of the support member 108 is disposed relatively perpendicular to the lengthwise axis 114. However, in alternative embodiments, a support member can extend from a portion of a main body top, from a portion of a main body first side, from a portion of a main body second side, and/or from any other portion of a carabiner and at any suitable angle relative to a lengthwise axis. In some embodiments, a support member is a bracket. However, a support member can be any suitable structure that can receive another structure. In the illustrated embodiment, the support member 108, along with the main body 104, forms a relatively rectangular shape. However, in alternative embodiments, a support member can form any suitable shape including, but not limited to, a shape that is circular, triangular, trapezoidal, or octagonal. The support member 108 is configured to create separation between the elongate member 130 and the void 126 to prevent obstruction and entanglement between components during use.

The bridge 150 extends from the main body first side 120 to the main body second side 122. The bridge 150 is configured to retain a second elongate member 148, when attached to the carabiner 102, in a desired location so that the second elongate member 148 does not interfere with the use of a catch 106 and so that the second elongate member 148 does not become free of the main body 104. In the illustrated embodiment, the bridge 150 extends from the carabiner first side 120 and away from the main body top 116 at an angle 121 that is less than 90 degrees. However, in alternative embodiments, a bridge can extend at any suitable angle relative to a main body first side. While shown, a bridge can optionally be omitted from a deployment device. Alternatively, the bridge 150 can be any type of structure that is configured to create separation between the second elongate member 148 and the void 126 to prevent obstruction and entanglement between components during use.

The elongate member 130 is attached to the support member 108 and has an elongate member first end 132, an elongate member second end 134, an elongate member first side 136, and an elongate member second side 138. The elongate member 130 extends from the elongate member first end 132 to the elongate member second end 134. The elongate member second side 138 opposably faces the elongate member first side 136. A portion of the elongate member 130 is attached to the support member 108. In the illustrated embodiment, a portion of the elongate member 130 is disposed between the support member 108 and the main body top 116. In the embodiment shown, the elongate member 130 has a length 131 about that is about 7.5 inches and a width 133 that is about 1.5 inches. While particular dimensions have been described, an elongate member can have any suitable dimensions including, but not limited to, 5.5-9.5 inches in length and 0.75-2.25 in width. In the illustrated embodiment, the elongate member 130 is approximately 9.5 inches from the elongate member first end 132 to the elongate member second end 134 when the elongate member 130 is not secured to the carabiner 102. In the illustrated embodiment, the elongate member 130 is formed of leather. However, in alternative embodiments, an elongate member can be formed of any suitable material including, but not limited to, polymers and elastomers.

The first attachment member 140 is attached to the elongate member 130 between the elongate member first end 132 and the elongate member second end 134. In the embodiment shown, the first attachment member 140 is attached to the elongate member first side 136. However, in alternative embodiments, a first attachment member can be attached to an elongate member second side. The first attachment member 140 comprises a first magnetic element.

The second attachment member 142 is attached to the elongate member between the first attachment member 140 and the elongate member second end 134. In the embodiment shown, the second attachment member 142 is attached to the elongate member first side 136. However, in alternative embodiments, a second attachment member can be attached to an elongate member second side. The second attachment member 142 comprises a second magnetic element. The second magnetic element is adapted to interact with the first magnetic element such that the first magnetic element and the second attachment element are magnetically attracted to one another. Example materials considered suitable to form a magnetic element include, but are not limited to, ferromagnetic materials, Iron, Cobalt, Nickel, Gadolinium, Dysprosium, Neodymium, Samarium, Terbium, Chromium, magnets, and any other magnetic elements considered suitable for a particular embodiment. In the illustrated embodiment, the first attachment member 140 is a piece of metal, such as a washer, and the second attachment member 142 is a magnet. However, in alternative embodiments, a piece of metal and a magnet can be switched, or a first attachment member and a second attachment member can both be magnets.

The handle 146 is attached to the elongate member 130. In the embodiment shown, the handle is attached to the elongate member second side 138 between the second attachment member 142 and the elongate member second end 134. As shown, the handle 146 is a partial sphere that is releasably attached to the elongate member 130 by a washer and a bolt. However, a handle can alternatively be fixedly, or permanently, attached to an elongate member using any suitable technique or method of attachments, such as using an adhesive or other mechanical means. In the illustrated embodiment, the partial sphere has a diameter 147 of 2 inches. However, a partial sphere can have any suitable diameter including, but not limited to, diameters equal to, greater than, or less than, 1 inch, 3 inches, 4 inches, and 5 inches, and any other diameter considered suitable for a particular embodiment. Although the illustrated embodiment shows the handle 146 as being a partial sphere, a handle can have any suitable geometric shape. The inclusion of a partial sphere allows a user, such as a firefighter, to easily grab the handle 146, even with gloves on, in hazardous situations. In some embodiments, a handle can contain glow-in-the-dark materials that provide visibility in dark situations, which allows a user, such as a firefighter, to see the handle in dark conditions.

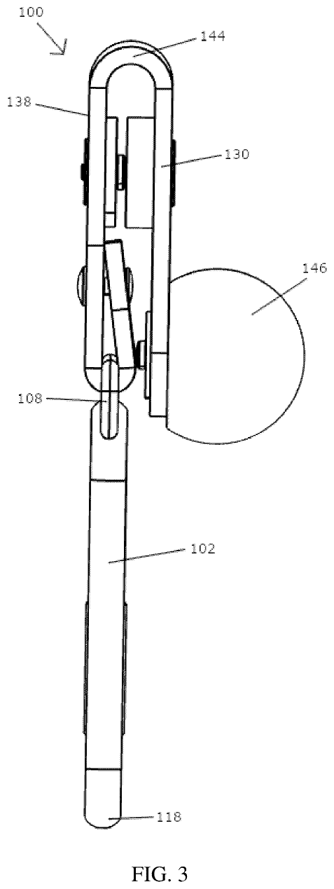

The elongate member 130 has a first configuration, as illustrated in FIGS. 1 and 2, and a second configuration, as illustrated in FIG. 3. When the elongate member 130 is in the first configuration, the first attachment member 140 is free of contact with the second attachment member 142, so the deployment device 100 can be removed from an article of clothing, such as a pocket of a pair of pants or a backpack. When the elongate member 130 is in the second configuration, the elongate member 130 defines a bend 144 and can be attached to an article of clothing. For example, the bend 144 allows an article of clothing, such as a portion of a pocket on a pair of pants, to be disposed between the first attachment member 140 and the second attachment member 142. By positioning a portion of an article of clothing between the first attachment member 140 and the second attachment member 142, the deployment device 100 is prevented from moving, or becoming dislodged, during use until a user moves the deployment device 100 from the second configuration to the first configuration. In addition, by positioning a portion of an article of clothing between the first attachment member 140 and the second attachment member 142, a firefighter can identify where the deployment device 100 is positioned on the article of clothing. When a firefighter needs to deploy the deployment device 100, the firefighter grabs the handle 146 and applies an upwards motion to move the elongate member 130 from the second configuration to the first configuration. In alternative embodiments, a deployment device can include an elongate member, similar to that described herein, and exclude a carabiner depending on what type of object a user is attempting to deploy, as a carabiner is not necessary for deploying certain objects.

Optionally, as shown in FIG. 2, the deployment device 100 can include a second elongate member 148 is attached to the carabiner bottom 118. The second elongate member 148 can be attached to the carabiner bottom 118 in any suitable manner, such as, but not limited to, tying the second elongate member 148 to the carabiner bottom 118. In the illustrated embodiment, the second elongate member 148 is a webbing strap. However, a second elongate member can be any desired object including, but not limited to, rope, other types of straps, and the same. The second elongate member 148 can be used for any intended purpose and can be swapped out to be any desired object an individual is trying to deploy from a pocket. Therefore, in alternative embodiments, a second elongate member could be a key, or a plurality of keys, a pocket knife, or any other object.

Various methods of using a deployment device, such as an embodiment described herein, are described herein. While these methods are described as a series of acts, it is to be understood and appreciated that the methods are not limited by the order of acts, as some acts may be in accordance with these methods, occur in the order described, in different orders, concurrently with other acts described herein, and/or be omitted.

A method of using a deployment device is described. A step includes partially inserting a deployment device into a pocket. Another step includes placing a portion of the pocket between a first attachment member and a second attachment member such that the handle remains outside of the pocket. Another step comprises moving the elongate member from the first configuration to the second configuration. Another step includes grabbing the handle. Another step includes applying a force on the handle away from the pocket to move the elongate member from the second configuration to the first configuration. Another step comprises removing the deployment device from the pocket.

Those with ordinary skill in the art will appreciate that various modifications and alternatives for the described and illustrated examples can be developed in light of the overall teachings of the disclosure, and that the various elements and features of one example described and illustrated herein can be combined with various elements and features of another example without departing from the scope of the invention. Accordingly, the particular examples disclosed herein have been selected by the inventors simply to describe and illustrate examples of the invention and are not intended to limit the scope of the invention or its protection, which is to be given the full breadth of the appended claims and any and all equivalents thereof.

1-19. (canceled)

20. A deployment device, comprising:
an elongate member having an elongate member first end and an elongate member second end;
a first attachment member attached to the elongate member between the elongate member first end and the elongate member second end, the first attachment member comprising a first magnetic element;
a second attachment member attached to the elongate member between the first attachment member and the elongate member second end, the second attachment member comprising a second magnetic element adapted to interact with the first magnetic element such that the first magnetic element and the second attachment element are magnetically attracted to one another; and
a handle attached to the elongate member between the second attachment member and the elongate member second end.

21. The deployment device of claim 20, wherein the elongate member has an elongate member first side and an elongate member second side;
wherein the first attachment member is attached to the elongate member first side;
wherein the second attachment member is attached to the elongate member first side; and
wherein the handle is attached to the elongate member second side.

22. The deployment device of claim 20, wherein the first attachment member is a piece of metal; and
wherein the second attachment member is a magnet.

23. The deployment device of claim 20, wherein the first attachment member is a magnet; and
wherein the second attachment member is a magnet.

24. The deployment device of claim 20, wherein the elongate member has a first configuration and a second configuration;
wherein the elongate member defines a bend in the second configuration; and
wherein the first attachment member contacts the second attachment member when the elongate member is in the second configuration.

25. The deployment device of claim 24, wherein the first attachment member is free of contact with the second attachment member when the elongate member is in the first configuration.

26. The deployment device of claim 20, wherein a portion of the elongate member is attached to a support member.

27. The deployment device of claim 20, wherein the elongate member has a length of 9.5 inches.

28. The deployment device of claim 27, wherein the elongate member has a width of 1.5 inches.

29. The deployment device of claim 20, wherein the handle is a partial sphere.

30. The deployment device of claim 29, wherein the handle has a diameter of 2 inches.

31. The deployment device of claim 20, wherein the handle is releasably attached to the elongate member.

32. The deployment device of claim 20, wherein the handle is fixedly attached to the elongate member.

33. The deployment device of claim 20, wherein the elongate member is formed of leather.

34. The deployment device of claim 20, wherein the handle contains glow-in-the-dark materials.

35. The deployment device of claim 20, wherein the elongate member is formed of a polymer.

36. The deployment device of claim 20, wherein the elongate member is formed of an elastomer.

37. A deployment device, comprising:
an elongate member having an elongate member first end and an elongate member second end, the elongate member having a first configuration and a second configuration, the elongate member defining a bend in the second configuration;
a first attachment member attached to the elongate member between the elongate member first end and the elongate member second end, the first attachment member comprising a first magnetic element;
a second attachment member attached to the elongate member between the first attachment member and the elongate member second end, the second attachment member comprising a second magnetic element adapted to interact with the first magnetic element such that the first magnetic element and the second attachment element are magnetically attracted to one another; and
a handle attached to the elongate member between the second attachment member and the elongate member second end, the handle comprising a partial sphere;
wherein the first attachment member is free of contact with the second attachment member when the elongate member is in the first configuration; and
wherein the first attachment member contacts the second attachment member when the elongate member is in the second configuration.

38. The deployment device of claim 37, wherein the first attachment member is a magnet; and
wherein the second attachment member is a magnet.

39. A deployment device, comprising:
an elongate member having an elongate member first end and an elongate member second end, the elongate member having a first configuration and a second configuration, the elongate member defining a bend in the second configuration;
a first attachment member attached to the elongate member between the elongate member first end and the elongate member second end, the first attachment member comprising a first magnetic element;
a second attachment member attached to the elongate member between the first attachment member and the elongate member second end, the second attachment member comprising a second magnetic element adapted to interact with the first magnetic element such that the first magnetic element and the second attachment element are magnetically attracted to one another; and
a handle attached to the elongate member between the second attachment member and the elongate member second end, the handle comprising a partial sphere, the handle contains glow-in-the-dark materials;
wherein the first attachment member is free of contact with the second attachment member when the elongate member is in the first configuration; and
wherein the first attachment member contacts the second attachment member when the elongate member is in the second configuration.
